(19) United States
(12) Patent Application Publication
(10) Pub. No.: US 2013/0091029 A1
(43) Pub. Date: Apr. 11, 2013

(54) SYSTEM, METHOD AND APPARATUS FOR CREATING PERSONALIZED PRODUCTS, GIFTS AND SOUVENIRS

(71) Applicant: MAGIC MOMENTS MEDIA, LLC, Troy, MI (US)

(72) Inventors: Trevor George, Troy, MI (US); Blake Michael George, Farmington Hills, MI (US); Linden Nelson, Pontiac, MI (US); Sanford Nelson, Pontiac, MI (US)

(73) Assignee: MAGIC MOMENTS MEDIA, LLC, Troy, MI (US)

(21) Appl. No.: 13/648,966

(22) Filed: Oct. 10, 2012

Related U.S. Application Data
(63) Continuation of application No. 61/545,249, filed on Oct. 10, 2011.

(51) Int. Cl. G06Q 30/00; G06Q 20/20

(52) U.S. Cl. 705/21; 705/26.5

(57) ABSTRACT

The present invention relates to a system, method and computer-readable storage medium for online merchandising. The system comprises an online marketplace and/or a mobile marketplace and a mobile application. The online marketplace provides a marketplace for selling products created by a user. The mobile application is configured to be installed on a hand-held device and associate the user with the online marketplace. The mobile application receives an image from local storage on the hand-held device. The mobile application receives images of physical products for selection by the user. The mobile application provides an interface to superimpose the photo onto the product and receives gestures from the user manipulating the interface. The mobile application is also configured to provide an option to automatically publish the created product to the online marketplace.

### CROSS-REFERENCE TO RELATED PATENT APPLICATIONS

This application claims the benefit of U.S. Provisional Patent Application No. 61/515,249, filed Oct. 10, 2011, which is hereby incorporated by reference herein in its entirety.

### FIELD OF THE INVENTION

The present invention relates to creating personalized products, gifts, and souvenirs. The present invention also relates to a systems, methods, and computer-readable storage medium for providing online merchandising including user-created products and merchandising such products.

### BACKGROUND OF THE INVENT :ON

In the past, when a consumer takes a photograph and then wishes to have the photograph incorporated onto a product, such as a T-shirt, the consumer had to proceed through a time consuming process or download a mobile application that must use another application as a patchwork solution. Some of the steps may have included uploading the picture to a computer, potentially editing the picture, and then ordering a customized product “on-line”, i.e., via the Internet. The “ordering” of the product would include uploading the edited picture, selecting the product, and thereafter, placing the order via an e-commerce platform, including making arrangements to pay for the product. Of course the first step, taking the photograph, usually occurred one or more days before the consumer uploads the pictures to the computer. Even if the picture was taken while the consumer was “near” a computer, such as while the consumer was at home, there were still a series of time-consuming steps to transfer the picture to the computer, etc.

Thus prior to the present invention, there was no “real time” system for ordering products incorporating a picture, i.e., there was no available system for taking a picture, or a series of pictures, selecting the desired picture, editing the picture and selling the merchandise on a real-time basis. Furthermore, prior to the present invention, there was no system available for using a hand-held device such as a mobile phone to take pictures and then place an order for customized merchandise, i.e., merchandise incorporating the picture, directly from the mobile phone.

It is an object of the present invention to obviate and mitigate at least one of the disadvantages of the prior art.

### SUMMARY OF THE INVENTION

The present invention relates to a system, method, and computer-readable storage medium for creating user-created (e.g., personalized) products. In a non-limiting example, the products may be customized or personalized by incorporating a photograph on the product. The product may be given away as a gift or may be maintained as a souvenir or keepsake. The product itself may have a utilitarian function, as will be explained below, or may be solely for display purposes.

One of the key features of the present invention is that the consumer may take a picture, via a hand-held device, such as but not limited to a mobile phone, and thereafter, order a customized product that incorporates the picture,

According to the principles of the invention, a method can be provided for creating and selling user-customized products, the method comprising providing a create-and-sell mobile application configured to be installed on a hand-held device to add a new resident application on the hand-held device and when installed associates a user of the resident application with an online marketplace for selling products created by the user in the resident application. The method also comprises receiving within the resident application an image from an onboard source of locally-generated content on the hand-held device. The method further comprises receiving, within the resident application, product images for physical products that can be sold by the user on the online marketplace through local user-interaction with the resident application. The method comprises providing an interface within the resident application that is configured to permit the user of the hand-held device to use a display of the hand-held device to superimpose the received image on at least one of the product images, whereby the user creates a new product. The method also comprises receiving gestures from the user to manipulate the interface. The method further comprises providing a selectable option within the resident application that when selected instructs the online marketplace to automatically contain a point of sale that merchandises the created product over the Internet and establishes a financial relationship between the user and the online marketplace.

In one embodiment, the method may also comprise providing a second selected option within the mobile application that when selected instructs a social network to automatically publish the image or created product to an account of the social network associated with the user. In another embodiment. The interface further comprises displaying status and information about other users associated with the social network account associated with the user. In yet another embodiment, the resident application further comprises providing a design center for editing the selected image. In another embodiment, the method may comprise wherein the financial relationship between the user and the online marketplace includes the user receiving a percentage of the sales of the user's created product. In yet another embodiment, the method may comprise receiving an incoming order of the created product from the online marketplace, receiving financial relationship information about a customer from the online marketplace, processing the order, and providing the customer with progress of the order.

According to the principles of invention, a system can be provided for creating and selling user-customized products, the system comprising an online marketplace for selling products created by a user. The system also comprises a create-and-sell mobile application that is configured to be installed on a hand-held device to add a new resident application on the hand-held device and when installed associates the user of the resident application with the online marketplace for selling products created by the user in the resident application. The create-and-sell mobile application further configured to receive within the resident application an image from an onboard source of locally-attenerated content on the hand-held device. The create-and-sell mobile application also configured to receive, within the resident application, product images for physical products that can be sold by the user on the online marketplace through local user-interaction with the resident application. The create-and-sell mobile application further configured to provide an interface within the resident application that is configured to permit the user of the hand-held device to use a display of the hand-held device to superimpose the received image on at least one of the product images whereby the user creates a new product. The create-and-sell mobile application configured to receive gestures from the user to manipulate the interface. The create-and-sell resident application also configured to provide a selectable option within the resident application that when selected instructs the online marketplace to automatically contain a point of sale that merchandises the created product over the Internet and establishes a financial relationship between the user and the online marketplace. In one embodiment, the system may also include an application server that facilitates communication between the online marketplace and the create-and-sell mobile application,

According to the principles of invention, a computer-readable storage medium comprising instructions executable by a processor to perform a method can be provided for creating and selling user-customized products, the method comprises providing a create-and-sell mobile application configured to be installed on a hand-held device to add anew resident application on the hand-held, device and when installed associates a user of the resident application with an online marketplace for selling products created by the user in the resident application. The method also comprises receiving within the resident application an image from an onboard source of locally-generated content on the hand-held device. The method further comprises receiving, within the resident application, product images for physical products that can be sold by the user on the online marketplace through local user-interaction with the resident application. The method comprises providing an interface within the resident application that is configured to permit the user of the hand-held device to use a display of the hand-held device to superimpose the received image on at least one of the product images, whereby the user creates a new product. The method also comprises receiving gestures from the user to manipulate the interface. The method further comprises providing a selectable option within the resident application that when selected instructs the online marketplace to automatically contain a point of sale that merchandises the created product over the

Internet and establishes a financial relationship between the user and the online marketplace.

According to the principles of invention, a method can be provided for creating and buying user-customized products, the method comprises providing a create-and-buy mobile application configured to be installed on a hand-held device so that when installed a new resident application is added to the hand-held device. The method also comprises receiving within the resident application a user-created image from an onboard source of locally-generated content on the hand-held device. The method further comprises receiving, within the resident application, product images whereby the user creates anew product. The method comprises providing an interface within the resident application that is configured to permit the user of the hand-held device to use a display of the hand-held device to superimpose the received user-created image on at least one of the product images, whereby the user creates a new product. The method also comprises receiving gestures from the user to manipulate the interface. The method further comprises providing a selectable option within the mobile application that when selected instructs the resident application to transmit data representative of the created product to a server over the Internet and establishes a financial relationship between the user and the server in connection with the created product.

According to the principles of invention, a method can be provided for creating and buying user-customized products, the method comprises providing a create a product mobile application configured to be installed on a hand-held device an that when installed a new resident application is added to the hand-held device. The method also comprises receiving within the resident application a user-created image from an onboard source of locally-generated content on the hand-held device. The method further comprises receiving, within the resident application, product images for physical products that can be used by the user to create customized new products. The method comprises establishing a fulfillment relationship for fulfilling orders or customized products created in the resident application between the resident application and a infillment application, wherein the fulfillment application is configured to receive information from the resident application and coordinate incorporation of images into products and shipping of finished products to one or more destinations for individual finished products. The method comprises providing an interface within the resident application that is configured to permit the user of the hand-held device to use a display of the hand-held device to superimpose the received user-created image on at least one of the product images, whereby the user creates a new product. The method further comprises providing a selectable option within the resident application that when selected instructs the resident application to transmit data representative of the created product to the fulfillment application over the Internet and establishes a financial relationship between the user and the fulfillment application in connection with the created product.

According to the principles of invention, a system for creating and buying user-customized products, the system comprising a create a product mobile application that is configured to be installed on a hand-held device to add a mobile application on the hand-held device so that when installed a new resident application is added to the hand-held device. The create a product mobile application also configured to receive within the resident application an user-created image from an onboard source of locally-generated content on the hand-held device. The create a product mobile application also configured to receive, within the resident application, product images for physical products that can be used by the user to create customized new products. The create a product mobile application further configured to establishing a fulfillment relationship for fulfilling orders of customized products created in the resident application between the resident application and a fulfillment application, wherein the fulfillment application is configured to receive information form the resident application and coordinate incorporation of images into products and shipping of finished products to one or more destinations for individual finished products. The create a product mobile application configured to provide an interface within the resident application that is configured to permit the user of the hand-held, device to use a display of the hand-held device to superimpose the received user-created image on at least one of the product images, whereby the user creates a new product. The create a product mobile application also configured to provide a selectable option within the mobile application that when selected, instructs the resident application to transmit data representative of the created product to the fulfillment application over the Internet and establishes a financial relationship between the user and the server in connections with the created product.

According to the principles of invention, a computer-readable storage medium comprising instructions executable by a processor to perform a method for creating and buying user-customized products, the method comprising providing a create a product mobile application configured to be installed on a hand-held device so that when installed anew resident application is added to the hand-held device. The method comprising receiving within the resident application a user-created image from an onboard source of locally-generated content on the hand-held device. The method further comprises receiving, within the resident application, product images for physical products that can be used by the user to create customized new products. The method also comprises establishing a fulfillment relationship for fulfilling orders of customized products created in the resident application between the resident application and a fulfillment application, wherein the fulfillment application is configured to receive information from the resident application and coordinate incorporation of images into products and shipping of finished products to one or more destinations for individual finished products. The method further comprises providing an interface within the resident application that is configured to permit the user of the hand-held device to use a display of the hand-held device to superimpose the received image on at least one of the product images, whereby the user creates a new product. The method also comprises providing a selectable option within the resident application that when selected instructs the resident application to transmit data representative of the created product to the fulfillment application over the Internet and establishes a financial relationship between the user and the fulfillment application in connection with the created product,

### BRIEF DESCRIPTION OF THE FIGURES

The present invention may be understood more fully by reference to the following detailed description of the preferred embodiment of the present invention, illustrative examples of specific embodiments of the invention and the appended figures in which:

FIG. 1 is a flow chart which will be used to further describe the system, method and apparatus in accordance with some embodiments of the present invention;

FIG. 2 is a flowchart of one embodiment of the create-and-sell mobile application process in accordance with some embodiments of the present invention;

FIG. 3 is a flowchart of another embodiment of the create-and-sell mobile application process in accordance with some embodiments of the present invention;

FIG. 4 is a flowchart of another embodiment of the create-and-sell mobile application process in accordance with some embodiments of the present invention;

FIG. 5 is a flowchart of one embodiment of the create-and-buy mobile application process in accordance with some embodiments of the present invention;

FIG. 6 is a block diagram of the system according to an embodiment of the invention;

FIGS. 7-19 are an examples of the interface of the mobile application in accordance with some embodiments of the present invention;

FIG. 20 is flow chart illustration the functionality of the system in accordance with some embodiments of the present invention; and

FIG. 21 is an example of the interface of the mobile application in accordance with some embodiments of the present invention.

### DETAIL DESCRIPTION OF THE PREFERRED EMBODIMENTS

The present system, method and apparatus will be described in connection with the figures, it being understood that the description and figures are for illustrative, non-limiting purposes.

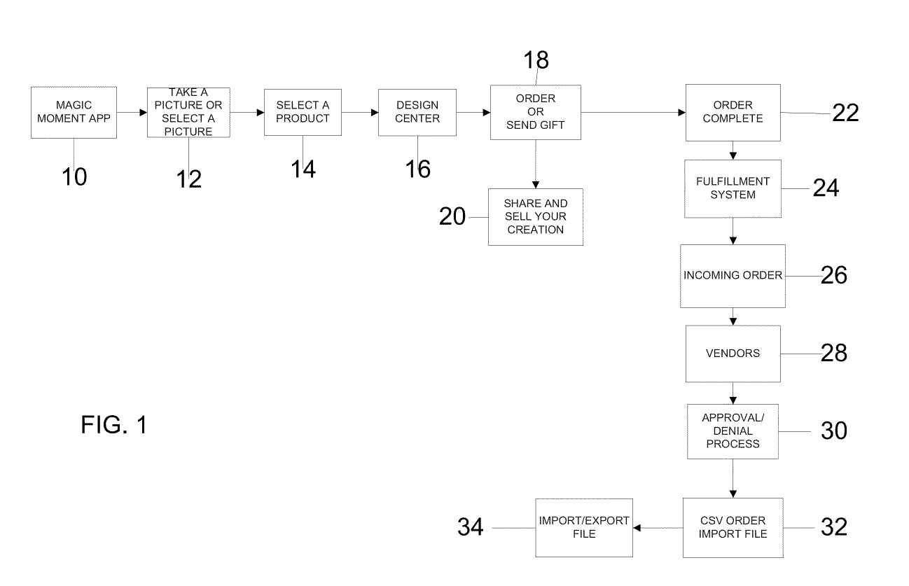

With reference to FIG. 1 a downloadable mobile application (mobile app) 10 can be provided that is downloaded into a cell phone or mobile phone (not shown) in a conventional manner. The consumer then uses the mobile phone to take one or more photographs and/or select from among the photographs stored in the mobile phone 12. The consumer then selects a product 14 to be customized. Among the non-limiting choices of products or merchandise would be clothing including but not limited to T-shirts, beverage containers including but not limited to drinking cups and coffee mugs, ornaments, computer accessories (mouse pads, computer bags), luggage, carrying cases for hand-held electronic devices, printed media (calendars, etc.), ceramic products including as “piggy banks”, picture frames and toys, it must be understood that the foregoing is a non-limiting example of the types of products or merchandise which may be customized.

A range of different types of products are also made available for creating new products by superimposing images onto the products. Also, the mobile application is configured to allow new types of products have different shapes and dimensions to be added into the application to expand the choices available to the users in creating new products,

Once the consumer has selected the photograph and the product, the mobile app has the consumer enter a virtual design center 16 where the consumer has the option to edit or modify the picture. The consumer may add borders to the picture, enhance color, brightness, crop the picture, etc. After the consumer is satisfied with any editing or modification of the picture, the consumer confirms the ordering of the product 18. Ordering the product includes making payment arrangements as well as identifying the destination where the product is to be delivered. Obviously, multiple products may be ordered and shipped to the same or multiple addresses. A gift card may be created as part of the ordering step. In addition, payment arrangements are to be made as part of the ordering of the product, Payment may be made through customary credit card channels, customary alternate arrangements and/or by charging to the mobile phone account. The consumer may also post the selected picture on the Internet via the consumer's Facebook account, etc., 20 and persons, which access to the consumer's account may be notified that the picture is available for viewing. The foregoing generally completes the “ordering” process and the sale or transaction is considered by the consumer to be completed 22.

The present system, method and apparatus includes fullfilment software 24 which receives the information via the mobile app and thereafter coordinates the incorporation of the photograph onto the selected product and shipping the finished product according to the shipping instinctions from the consumer,

In general terms the fulfillment software 24 receives the incoming order 26 (which corresponds to the completed order 18) and then confirms that satisfactory financial arrangements have been made, i.e., the approval and denying process 30, if the consumer's attempt to charge the transaction was rejected, the transaction is denied at step 30 and the consumer is notified. If the transaction is approved, the information is input into an order input file 32 which further processes the order including tracking the progress of the order and storing information about the order in the event of a later question.

The fulfillment software and order import file thereafter communicates electronically to the appropriate vendor/supplier of the selected merchandise 28, and forwards the selected photograph 12 and shipping information 18 (along with any gift card information) to the vendor. The system then monitors or tracks the fulfillment of the order via an import/export file 34 to confirm shipment of the customized merchandise to the consumer. The foregoing is a general explanation of the system, method and apparatus of the present invention.

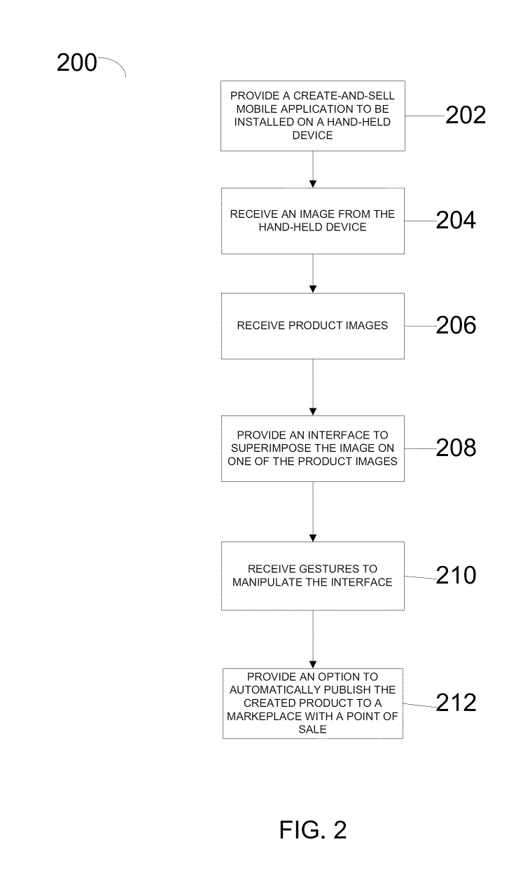

Referring to FIG. 2, which is a flowchart of one embodiment of the create-and-sell mobile application process (200). First, a create-and-sell mobile application is provided to be installed on a hand-held device (202). The hand-held device can be any number of portable computing devices including but not limited to a mobile phone, a tablet, a PDA, etc. The create-and-sell mobile application may be available for download to the hand-held device by any number of ways including but not limited to an application store, the Internet, a desktop computer, another hand-held device, etc. Once the create-and-sell mobile application is installed on the hand-held device, the application may become a resident application that resides on the hand-held device. Also, once the mobile application is installed, the mobile application may associate a user of the mobile application with an online marketplace for selling products created by the user in the resident application. The online marketplace may include a website for showcasing and viewing created products by other users. The online marketplace may also be viewable within the resident application. A resident application is different from a browser at least because it is specifically configured to add a new application to the user's device as opposed to a browser that provides access to Internet websites through user-selection of different destination addresses,

The resident application may receive one or more images from the hand-held device (204). The one or more images may be already stored locally on the hand-held device, such as pictures previously taken with a camera on the hand-held device or downloaded from another source. The one or more images may also be taken with a camera on the hand-held device within this step. The images may be locally created content on the hand-held device. The images may be photographs or other graphics/visuals created on the device or received on the device. Images do not necessarily have to be an image file but other file or data representative of an image, photograph, or other user-created graphics (e.g., art created using a painting application). In some embodiments, other images besides locally created images may be a source of images for the resident application. It should also be contemplated that other data or files representing a product, such as two-dimensional (2D) or a three-dimensional (3D) representation (e.g., a CAD file) for a product.

Then the resident application receives product images for physical products that may be sold by the user on the online marketplace through local user-interaction with the resident application (206). The product images are preferably received from an online source that is configured to send information to the resident application. Next, the resident application may provide an interface that is configured to permit the user of the hand-held device to use a display of the hand-held device to superimpose the received image on at least one of the product images (208). The result is a user-created new product. The resident application may also be configured to receive gestures from the user that manipulates the interface (210). The gestures received by the resident application may include, but are not limited to, gestures on a touch screen, gestures from a stylus, keypad, or number pad presses, etc. The resident application may also provide a selectable option that when selected, instructs the online marketplace to automatically contain a point of sale that merchandises the created product over the Internet and establishes a financial relationship between the user and the online marketplace (212).

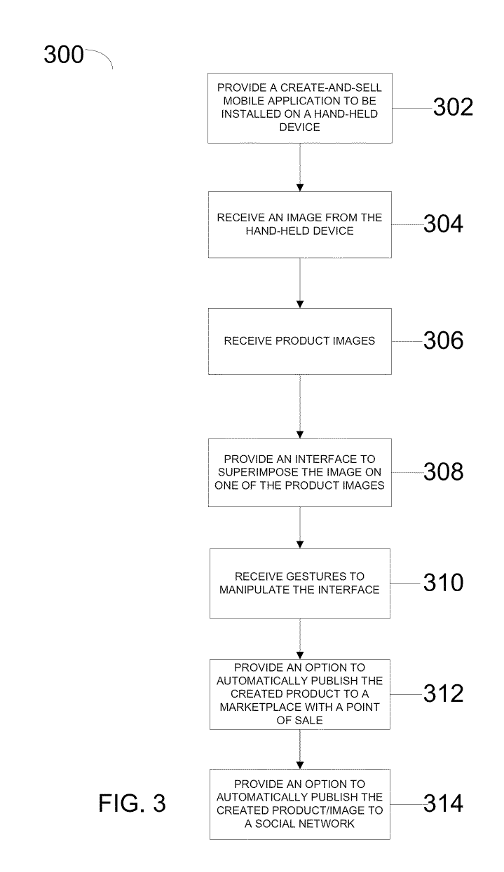

Now referring to FIG. 3, which is a flowchart of another embodiment of the create-and-sell mobile application process (300). A create-and-sell mobile application is provided to be installed on a hand-held device (302). Once the create-and-sell mobile application is installed on the hand-held device, the application may become a resident application that resides on the hand-held device. Next, resident application may receive one or more images from the hand-held device (304). Then, the resident application receives product images for physical products that may be sold by the user on the online marketplace through local user-interaction with the resident application (306). Next, the resident application may provide an interface that is configured to permit the user of the hand-held device to use a display of the hand-held device to superimpose the received image on at least one of the product images (308). The resident application may also be configured to receive gestures from the user that manipulates the interface (310). The resident application may also provide a selectable option that when selected, instructs the online marketplace to automatically contain a point of sale that merchandises the created product over the Internet and establishes a financial relationship between the user and the online marketplace (312). Then, the resident application may provide another option to automatically publish the created product or selected image to a social network (314). The user can choose to associate the resident application with various social network accounts. Therefore, if the user wants to publish the created products or images, it can happen with the push of a button.

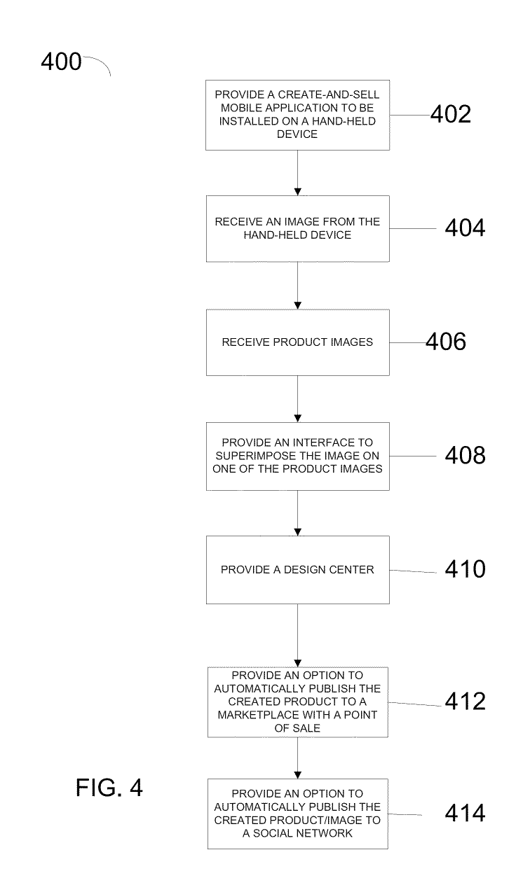

Now referring to FIG. 4, which is a flowchart of another embodiment of the create-and-sell mobile application process (400). A create-and-sell mobile application is provided to be ilustalled on a hand-held device (402). Once the create-and-sell mobile application is installed on the hand-held device, the application may become a resident application that resides on the hand-held device. The resident application may then receive one or more images from the hand-held device (404). Then, the resident application receives product images for physical products that may be sold by the user on the online marketplace through local user-interaction with the resident application (406). Next, the resident application may provide an interface that is configured to permit the user of the hand-held device to use a display of the hand-held device to superimpose the received image on at least one of the product images (408). The resident application may provide a design center within the interface (410). The design center may provide options to edit the selected image, such as crop, blur, or rotate and may also provide the option to add filters, text, color, frames, borders, and patterns.

The resident application may also provide a selectable option that when selected, instructs the online marketplace to automatically contain a point of sale that merchandises the created product over the Internet and establishes a financial relationship between the user and the online marketplace (412). The resident application may then provide another option to automatically publish the created product or selected image to a social network (414).

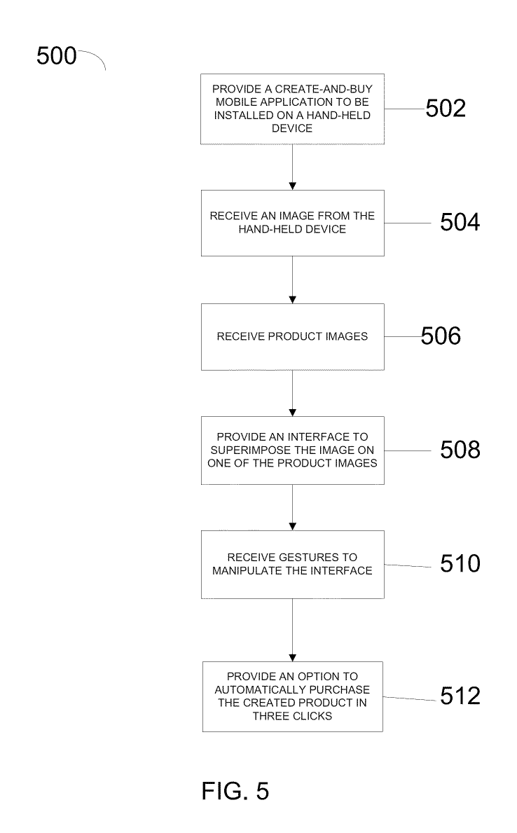

Now referring to FIG. 5, which is a flowchart of one embodiment of the create-and-buy mobile application process (500). A create-and-buy mobile application is provided to be installed on a hand-held device (502). Once the create-and-buy mobile application is installed, on the hand-held device, the application may become a resident application that resides on the hand-held device. The resident application may then receive one or more images from the hand-held device (504). Then, the resident application receives product images for physical products that may be bought by the user through the resident application (506). Next, the resident application may provide an interface that is configured to permit the user of the hand-held device to use the display of the hand-held device to superimpose the received image on at least one of the product images (508). The resident application may also be configured to receive gestures from the user that manipulates the interface (510). The gestures received by the resident application may include but are not limited to gestures on a touch screen, gestures from a stylus, keypad or number pad presses, etc,

The resident application may also provide a selectable option that when selected instructs the resident application to transmit the created product over the Internet and establishes a financial relationship between the user and the server (412). The resident application may then provide another option to automatically publish the created product or selected image to a social network (414). The overall create-and-buy process can happen very quickly and in as few as three gestures or selections of a button, etc. In some embodiments that employ this feature, this is a vast improvement over what was previously available with traditional digital camera, computer and browser combination that required several steps and several different interfaces and applications. The create-and-sell mobile application process can also happen in as few as three gestures or selections, as well.

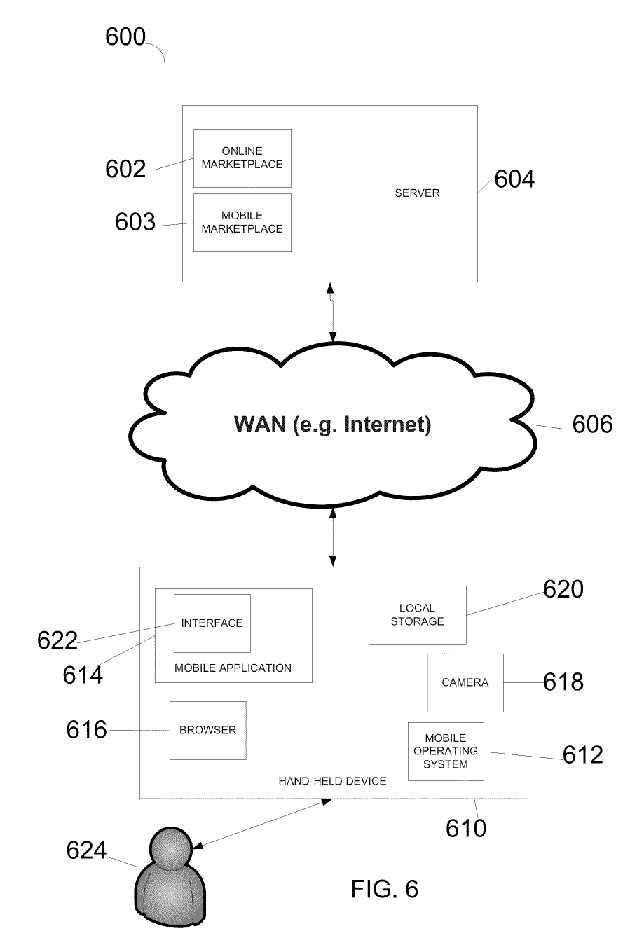

Now referring to FIG. 6, a block diagram of the online merchandising system according to an embodiment of the present invention (600). An online marketplace 602 is communicatively coupled to a server 604. The online marketplace 602 and the server 604 may be co-located or may be physically separated. The online marketplace 602 may provide any number of services to a user. For example, the online marketplace 602 may be the place that a created product by a user is made available for other users to view and buy. The online marketplace 602 may also include a social network aspect, where users can interact with each other, such as comment on created products and the like. The online marketplace 602 is also communication coupled to a mobile application 61.4.

A mobile marketplace 603 is also communicatively coupled to the server 604. The mobile marketplace 603 may also be communicatively coupled to the online marketplace 602. The mobile marketplace 603 may provide many different services, such as to send product images to a mobile interface (e.g., integrated into the resident application) for the online marketplace 602. The mobile marketplace 603 may also be communicatively coupled to a back end server that provides the same content over a web browser and over a mobile application. The mobile marketplace 603 may be co-located or physically separate from the online marketplace 602. The mobile marketplace 603 is also communicatively coupled to the mobile application 614. It is contemplated that there could be webpage-based marketplace accessible by a browser, and a mobile version accessible through a resident application on a hand-held device.

The mobile application 614 is installed and stored on a hand-held device 610. The hand-held device 610 may also include a mobile operating system 612, local storage 620, a camera 618, and a browser 616. The mobile operating system 612 may be smart phone mobile operating system, such as ADS, Android, Windows Phone, etc. The mobile operating system 612 manages mobile hardware resources and provides common services for the mobile applications. The local storage 620 may be used to store any type of data that needs to be stored on a hand-held device including but not limited to photographs, user information, contact data, other mobile applications, videos, music, etc.

The browser 616 on the hand-held device may be used to directly connect to the Internet and to type insert similar to using a browser on a desktop or laptop computer. The mobile application 614 may also include an interface 622. The interface 622 may be used to provide a method of interaction between the mobile application 614 and a user 624. The interthee 622 may be configured to receive gestures from the user 624 that manipulate the interface 622.

The hand-held device 610 and the server 604 may be communicatively coupled by a wide area network (WAN) 606. For example, the WAN 606 could be the Internet. The WAN may include wired, wireless networks and interconnection. If desired, the WAN may be a private network. The online marketplace 602 may also be communicatively coupled to the WAN 606 and the mobile application 614 may also be communicatively coupled to the WAN 606.

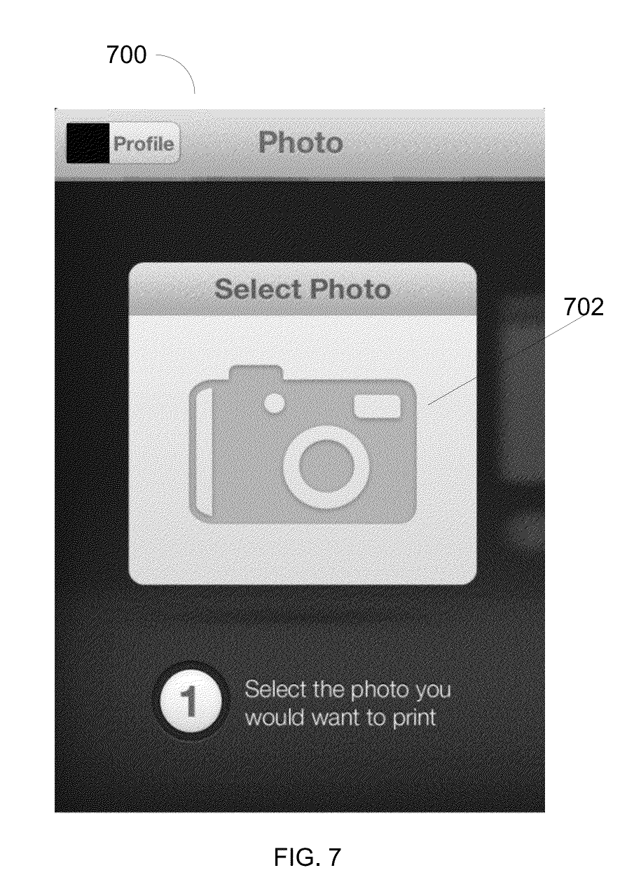

Now referring to FIG. 7, which is an exemplary interface of the mobile application 700. First, the mobile application is opened on the hand-held device. Once the mobile application is open, this interface 700 is an example of what the user may see. The user may have the option to select a photograph to use to create a product to buy sell and/or share. Interface 700 may include a select a photo button 702 to select a photo.

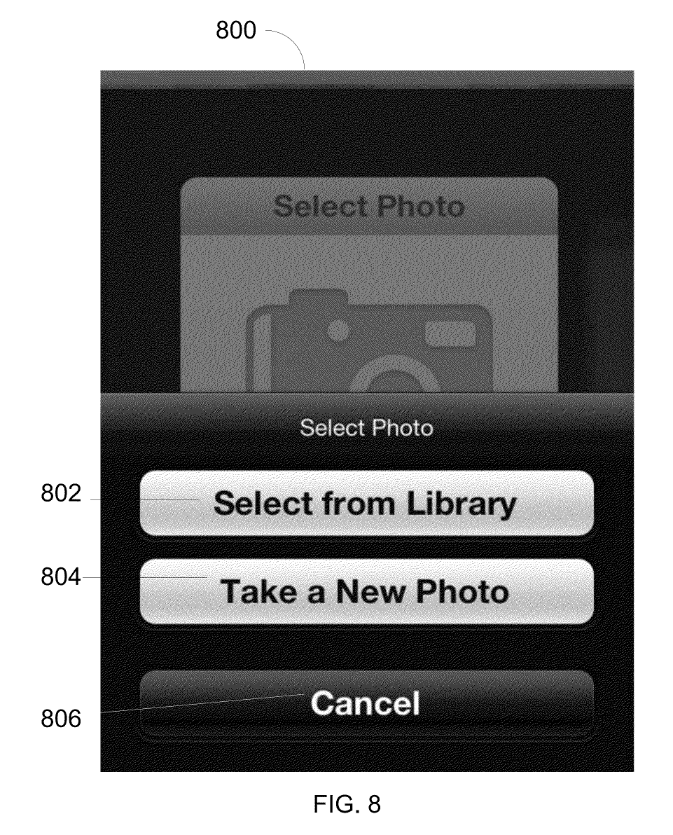

Now referring to FIG. 8, which is another exemplary interface of the mobile application 800. Once the user selects the select a photo button 702, the user may be presented with another set of options. The options may include a button 802 to select a photo from the photo library stored on the hand-held device. The photo library may be stored in the local storage on the hand-held device. The user may also be presented with a button 804 to take a new photo using the hand-held device's camera, Selecting button 804 may automatically open the application that controls the hand-held device's camera to allow the user to take a picture. The user may also be presented with cancel button 806, which may allow the user to go back to the previous screen.

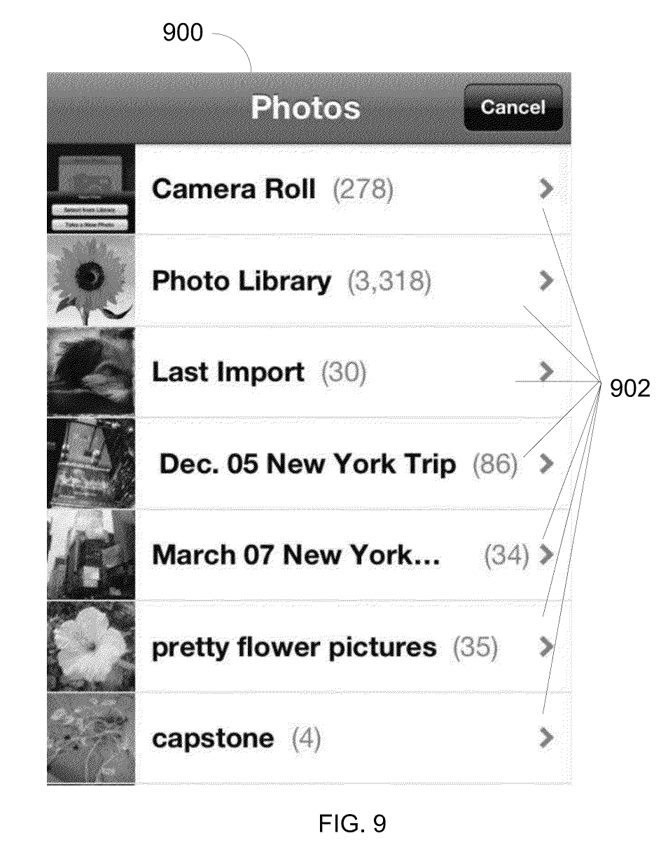

Now referring to FIG. 9, which is another exemplary Interface of the mobile application 900. Interface 900 is the result of selecting the select a photo button 802 from the previous screen. Interface 900 presents the user with all of the photos stored locally on the hand-held device 902. The user has the option to select one of these photos to use to create a product.

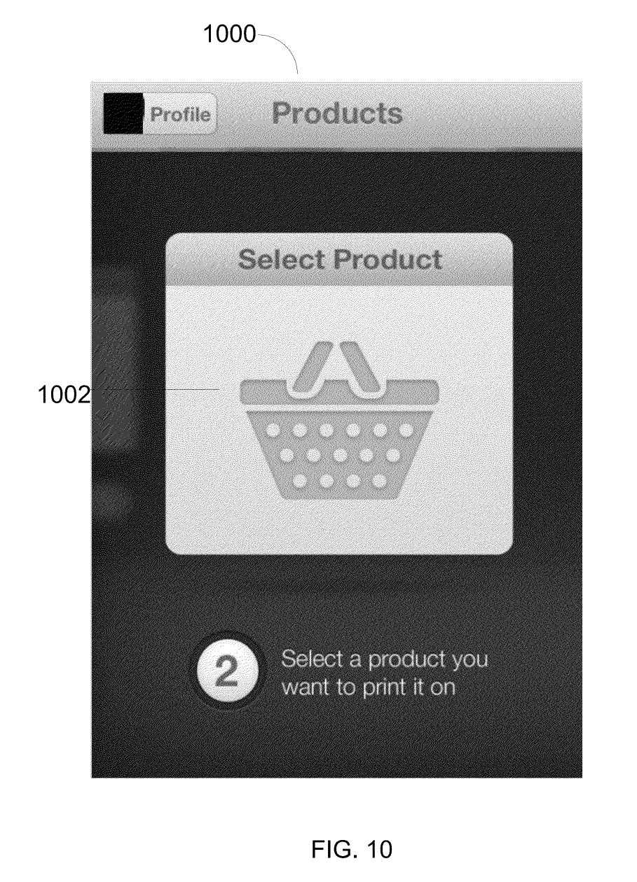

Now referring to FIG. 10, which is another exemplary interface of the mobile application 1000. Interface 1000 may be presented to the user after they have selected a photo or taken a photo. Interface 1000 may provide a Select Product button 1002, so that the user can select a product for the created product.

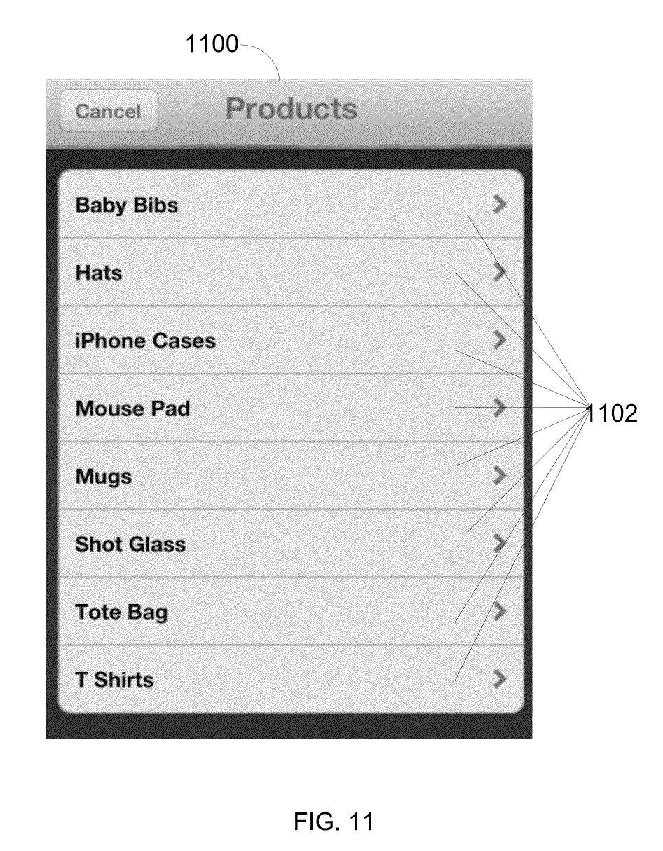

Now referring to FIG. 11, which is another exemplary interface of the mobile application 1100. Interface 1100 may be presented to the user after they have selected the Select Product button 1002 on the previous screen, interface 1100 may include a list of different products 1102 that the user can choose from to create a personalized product. The different list of products shown here is not au exhaustive list of products. The list shown on interface 1100 includes, but is not limited to, baby bibs, hats, iPhone cases, mouse pads, mugs, shot glasses, tote baiz. T-shirts. It should be appreciated that many more types of products could be included and is not limited to only these listed.

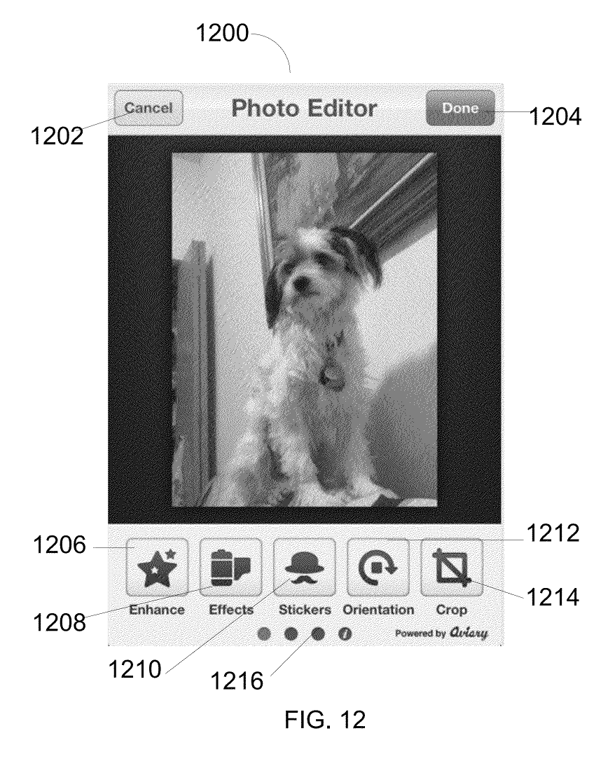

Now referring to FIG. 12, which is another exemplary interface of the mobile application 1200. Interface 1200 may be presented to the user after they have selected the type of product for the created product. Interface 1200 is an interface for providing a photo editor to the user. The user may be able edit the appearance of the photo in many different ways. Interface 1200 may include cancel button 1202, done button 1204, enhance button 1206, effects button 1208, stickers button 1210, orientation button 1212, crop button 1214, and menu location indicator 1216. The cancel button 1202 may either stop the entire process and go back to the main screen of the mobile application or may go back to the previous screen. The done button 1204 may save any changes to the product and image made during the editing process, and continue to the next screen.

The enhance button 1206 may include options including, but not limited to, auto enhance, night enhance, backlit, and/or balance. The effects button 1208 may include options of enhancing the photo with many different types of filters including, but not limited to, original, singe, vivid, San Carmen, indiglow, Concorde, aqua, strato, Laguna, Ventura, black and white, sepia, soft focus, etc. The stickers button 1210 may include the option of adding stickers to the photo including, but not limited to, hats, speech bubbles, and various other shapes.

The orientation button 1212 may include the options, such as rotating the image forward or backward 90 degrees or inverting the photo horizontally or vertically The crop button 1214 may provide the options including, but not limited to, a custom crop using grid lines super imposed over the image, keep the original image, crop the image into a perfect square, crop the image to a 3×2 image, crop the image to a 3×5 image, crop the image to a 4×3 image, crop the image to a 4×6 image, or crop the image to a 5×7 image.

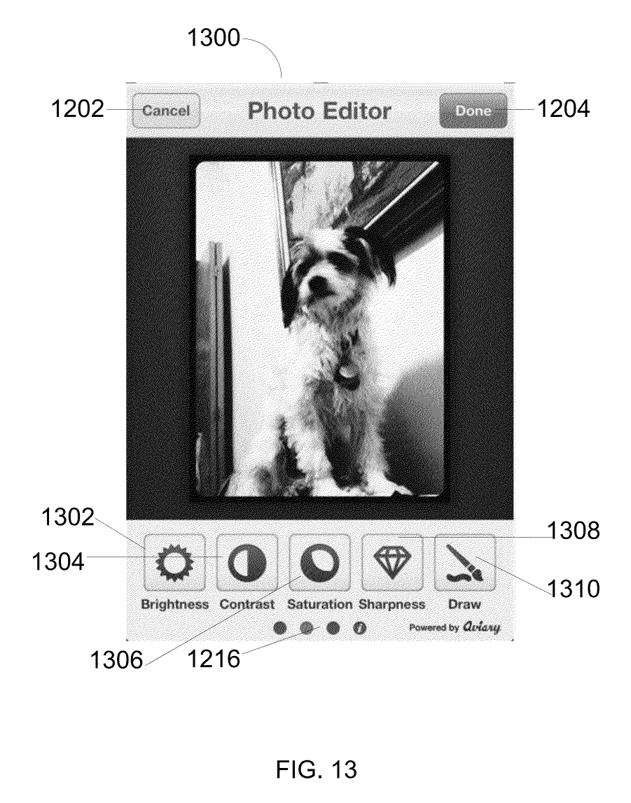

Now referring to FIG. 13, which is another exemplary interface of the mobile application 1300. Interface 1300 may be presented to the user when the user gestures across the buttons on interface 1200 at the bottom of the screen. A new set of buttons may be presented to the user for more options to edit the image. Examples of the types of buttons may include, but are not limited to, brightness button 1302, contrast button 1304, saturation button 1306, sharpness button 1308, and draw button 1310. The brightness button 1302 may provide a slider or a dial to allow the user to gesture to manipulate the brightness of the photo. The contrast button 1304 may also provide a slider or dial to allow the user to gesture to manipulate the contrast of the photo.

The saturation button 1306 may also provide a slider or a dial to allow the user to gesture to manipulate the saturation of the photo. The sharpness button 1308 may also provide a slider or a dial to allow the user to gesture to manipulate the sharpness of the photo. The draw button 1310 may provide the user to draw on the photo in various different colors, shapes, and sizes.

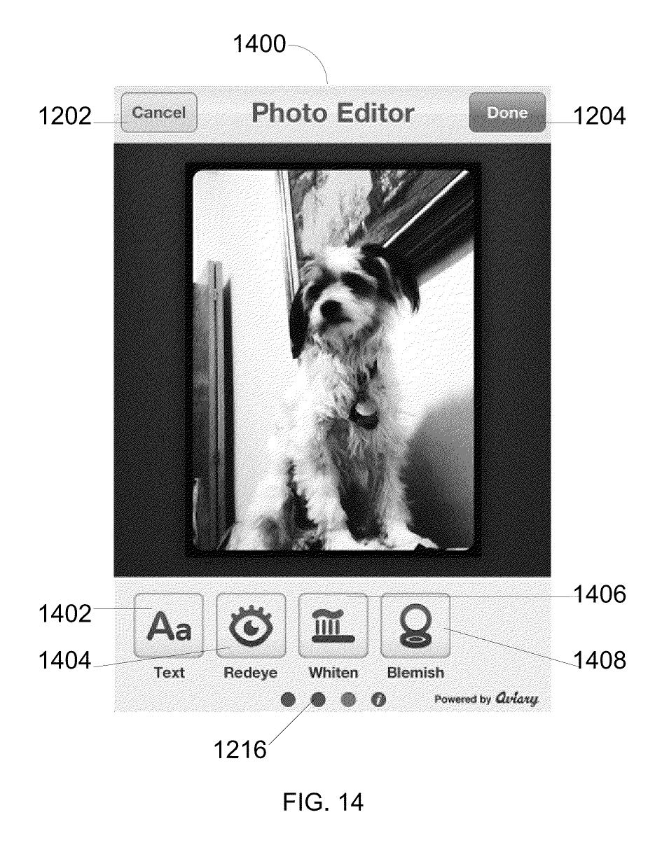

Now referring to FIG. 14, which is another exemplary interface of the mobile application 1400. Interface 1400 may be presented to the user when the user gestures across the buttons on interface 1300 at the bottom of the screen. In response, a new set of buttons may be presented to the user for more options to edit the image. Examples of the types of buttons may include, but are not limited to, text button 1402, redeye button 1404, whiten button 1406, and blemish button 1408. The text button 1402 may include, but is not limited to, providing the user the ability to add text to the image. The redeye button 1404 may include providing the user the ability to reduce or eliminate the appearance of the redeye effect, which is the appearance of red eyes in photos due to the use of a flash. The whiten button 1406 may include providing the user the ability to whiten certain aspects of the image, such as teeth. The blemish button 1408 may provide the user the ability to eliminate or reduce the appearance of blemishes in a photo.

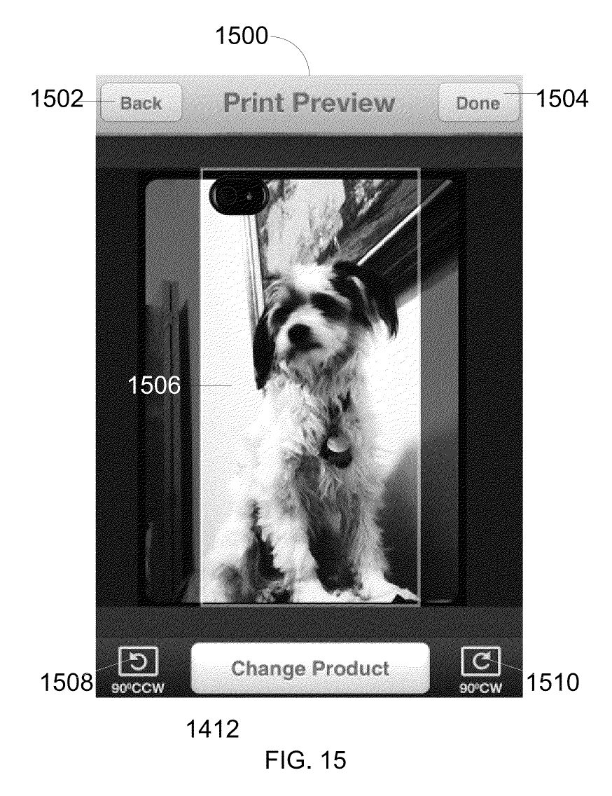

Now referring to FIG. 15, which is another exemplary interface of the mobile application 1500. Interface 1500 may be presented to the user after they have finished editing the photo. Interface 1500 may include, but is not limited to, back button 1502, done button 1504, photo placement view 1506, counterclockwise 90 degree turn button 1508, clockwise 90 degree turn button 1510, and change product button 1512. The back button 1502 may either take the user back to the beginning of the process or to the previous screen. The done button 1504 may save any changes made and proceed to the next screen. The photo placement view 1506 may provide the user with the ability to place a particular portion of the photo on the product in a particular place or manner. The counterclockwise 90 degree turn button 1508 may provide the user the ability to turn the photo 90 degrees counterclockwise. The clockwise 90 degree turn button 1510 may provide the user with the ability to turn the photo 90 degrees clockwise. The change product button 1512 may provide the user with the option to go back and change the product.

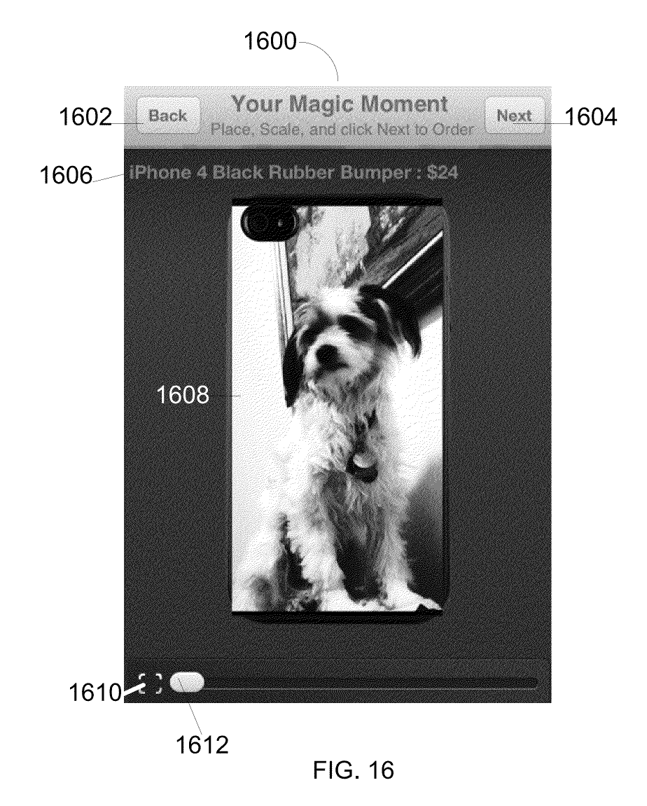

Now referring to FIG. 16, which is another exemplary interface of the mobile application 1600. Interface 1600 may be presented to the user after they have finished placing the photo on the product in the previous screen, interface 1600 may include, but is not limited to, back button 1602, next button 1604, title 1606, photo placement view 1608, border indicator 1610, and edge slider 1612. The back button 1602 may either take the user back the beginning of the process or take the user back to the previous screen. The next button 1604 may take the user to the next screen. The title 1606 may indicate to the user the type of product and the price of the product, or other information about the product. The photo placement view 1608 may allow the user to make final adjustments to the placement of the photo on the product. The border indicator 1610 may indicate to the user the type of border to be applied to the photo, such as square edges or rounded edges. The edge slider 1612 may provide the user the ability to slide to sharpen or dull the edges of the photo.

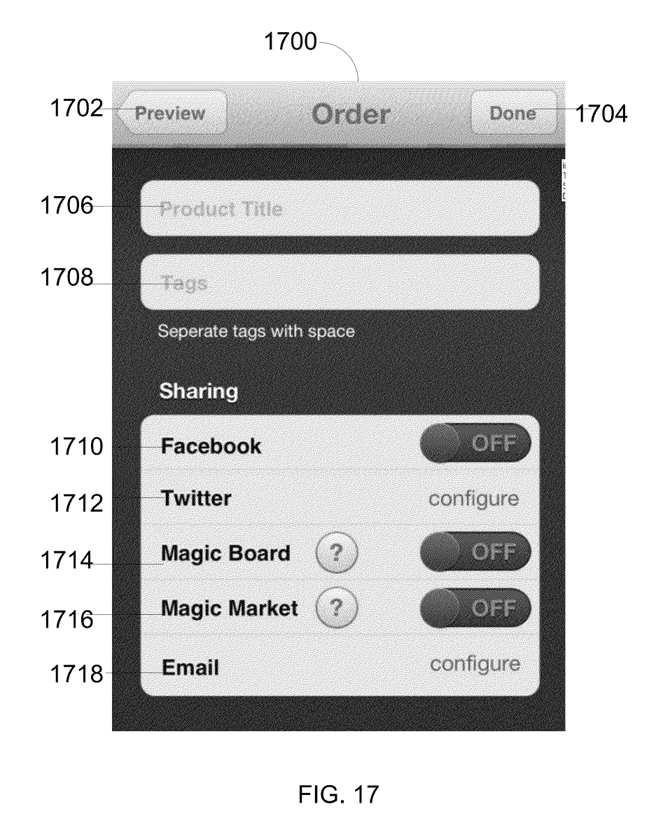

Now referring to FIG. 17, which is another exemplary interface of the mobile application 1700. Interface 1700 may be presented to the user after they have finished placing the photo on the product in the previous screen, Interface 1700 is an order screen that may include, but is not limited to, preview button 1702, done button 1704, product title field 1706, tag field 1708, Facebook option 1710. Twitter option 1712, Magic Board option 1714, Magic Market option 1716, and email option 1718. The interface 1700 is not limited to only these options. The interface 1700 may include more or less than the options described here. For example, there might also be an Instagram option or other photo sharing social network option. The preview button 1702 may provide the user to go back to the previous screen and preview what the created product looks like. The done button 1704 may take the user to the next screen,

It is possible that there are multiple preexisting connections or links to the user's social media networks and the interfaces described herein provides the user with the ability to select the networks within which the creation will be shared and prevent it from being shared in others, in the same or in a related screen, the user can select to control whether the creation is shared or made available publicly or in an online and/or mobile marketplace. This feature can be set for each customized product or if desired, configured across multiple products.

The product title field 1706 may provide the user the ability to name the product. The tag field 1708 may provide the user the ability to tag the created product with keywords that are relevant to the created product. The tags could be used to make the created product easily searchable for other users. The Facebook option 1710 may provide the user the ability to automatically post the photo or the created product via the user's

Facebook account. The Facebook option 1710 may also provide the user with a prompt or section to provide the account credentials so that the mobile application can log into the user's Facebook account on behalf of the user. Where Facebook is described it should also be appreciated that this could easily be any other social network and is not limited to Facebook,

The Twitter option 1712 may provide the user the option to automatically publish the photo or created product on the user's Twitter feed. The Twitter option 1712 may also provide a prompt or section to provide the account credentials so that the mobile application can log into the user's Twitter account on behalf of the user. The Magic Board option 1714 may provide the user access to a game based a popularity contest with one or more social networks. For example, if the user chooses the Magic Board option 1714 and uploads a photo or a created product to their social network, the Magic Board option 1714 may keep track of the number of likes, retweets, or the like, which contributes to points. The user with the most points each month might when a prize, such as cash, products, discounts, etc.

The Magic Market option 1716 may provide the user the ability to publish the created product to an online marketplace or a mobile marketplace for other users to purchase. The Magic Market may also include Magic Money that displays to the user the statistics of the sales of the created products. The user may receive a percentage of the revenue of any the user's created products. The user may choose to receive this money as a payment or may use any money earned to buy new products. The email option 1718 may provide the user the option to add their email address so that they can receive information pertaining to the created product. For example, if the user decides to purchase the created product, the user may receive shipping and tracking notifications. If the user decides to place the created product on the Magic Market, then the user might receive emails when the product is bought, liked, or retweeted by other users,

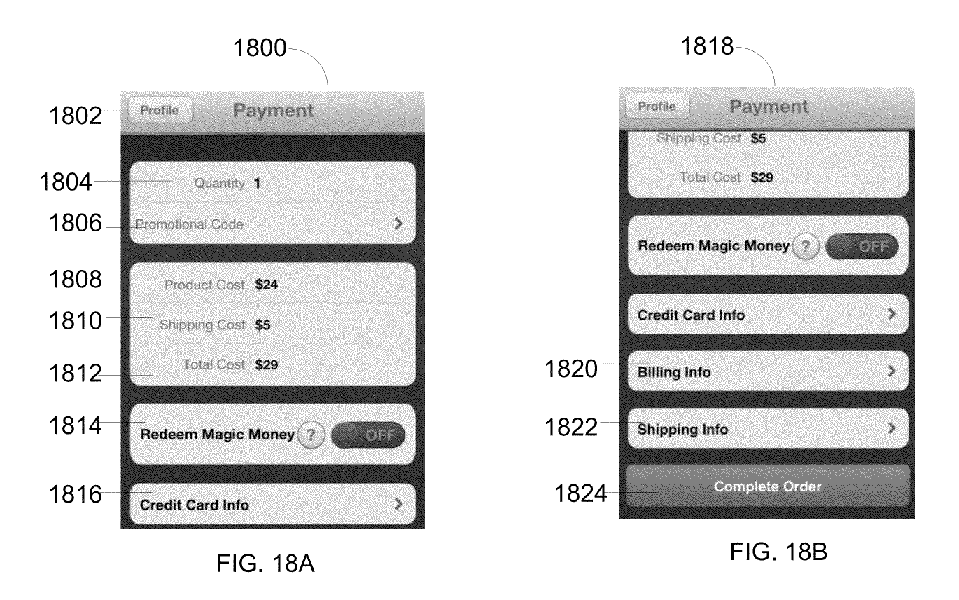

Now referring to FIGS. 18A and. 18B, which is another exemplary interface of the mobile application 1800. Interface 1800 may be presented to the user after they have finished the order screen, Interface 1800 may include, but is not limited to, profile button 1802, quantity selection button 1.804, promotion code field 1806, product cost field 1808, shipping cost field 1810, total cost field 1812, redeem Magic Money option 1814, credit card information field 1816, billing information field 1820, shipping information field 1822, and complete order button 1824.

The profile button 1802 may show the profile associated with the account of the mobile application or a profile of a social network. The quantity selection button 1804 may provide the user the ability to choose the number of products to purchase. The promotional code field 1816 may provide a text field for the user to apply a promotional code given to the user for discounts, free shipping, etc. The product cost field 1808 may illustrate to the user the cost of the product that was chosen. The shipping cost field 1810 may illustrate to the user the cost of shipping the product. The total cost field 1812 may illustrate to the user the total cost of the product and the shipping costs.

The redeem magic money option 1814 may provide the user the option to apply any magic money earned from the sales of previously created products, which may be deducted from the cost of the product. The credit card information field 1816 may provide the user the ability to enter credit card information to pay for the created product, such as credit card number, expiration date, security code, type of credit card, and name on credit card. The mobile application may also provide an option to save the credit card information for feature purchases. The billing information field 1820 may provide the user the ability to enter the billing information associated with the credit card the user previously entered in the credit card information field 1816. The shipping information field 1822 may provide the user to enter the shipping information if it is different from the information entered into the billing information field 1816. For example, the user may wish to use his personal credit card but have the product shipped to his place of business. The complete order button 1824 may use the information entered into interface 1800 and place the order. The order may be sent to a server. The server may send the order information to various vendors for producing the created product,

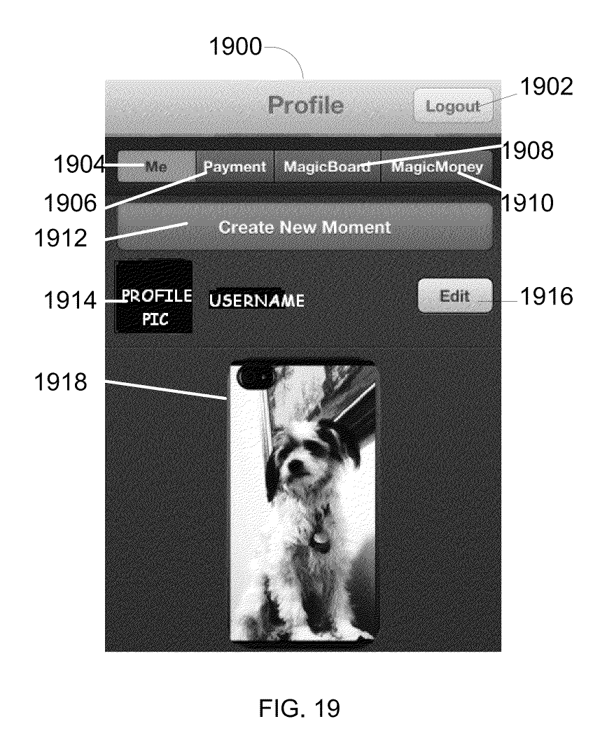

Now referring to FIG. 19, which is another exemplary interface of the mobile application 1900. Interface 1900 may be presented to the user after they have finished placing order of the created product on the previous screen. The interface 1900 may be a profile page for an account associated with the user of the mobile application. The interface 1900 may include, hut is not limited to, logout button 1902, me tab 1904, payment tab 1906, MagicBoard tab 1908, MagicMoney 1910, create new moment button 1912, profile picture and username 1914, edit button 1916, and previously created products 1918.

The logout button 1902 may logout the user of the account associated with the mobile application. The me tab 1904 may display profile information associated with the user of the mobile application previously created products and allow the user to create a new product. The payment tab 1906 may display many different types of payment information. For example, the type of payment information displayed may include hut is not limited to previously used credit card information, currently saved credit card information, etc. The MagicBoard tab 1908 may display a leader board type display to illustrate number of points of people within the user's social network and where each participating user stands in comparison to other users. The user with the most points in the popularity contest of created products wins for that time period,

The MagicMoney tab 1910 may display to the user different sales statistics of the sales of the user's created products. The display of the statistics can be in many different forms, such as graphs, charts, tables, etc. The create new moment button 1912 may provide the user the ability to create a new product. The profile picture and username 1914 may display the profile picture and username for a social ‘network associated with user's account or the profile picture and username for the account associated with the mobile application. The edit button 1916 may provide the user the ability to change the profile account, or make other changes. The previously created products 1918 may provide a visual or textual display of the created products associated with the profile currently logged into the mobile application (indicated by the profile picture and username 1914).

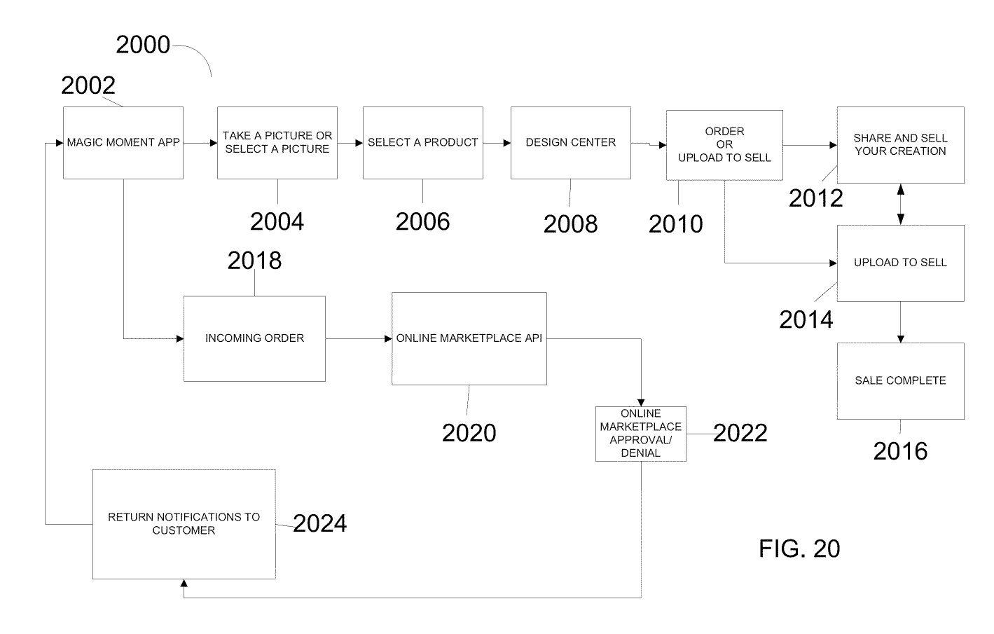

Now referring to FIG. 20, which is a flow chart illustration, the functionality of the system according to one embodiment of the present invention. In some embodiments, a downloadable mobile application 2002 is included. The mobile application 2002 is downloaded to a hand-held device (not shown) in a conventional manner. The user then uses the hand-held device to either take one or more photographs and/or select from among the photographs (2004) stored locally on the hand-held, device. The user then selects a product (2006) to be customized. Among the non-limiting choices of products or merchandise would be clothing including but not limited to T-shirts, beverage containers including but not limited to drinking cups and coffee mugs, ornaments, computer accessories (mouse pads, computer bags), luggage, carrying cases for hand-held electronic devices, printed media (calendars, etc.), ceramic products including as “piggy banks”, picture frames and toys. It must be understood that the foregoing is a non-limiting example of the types of products or merchandise which may be customized.

Once the user has selected the photograph and the product, the mobile application may provide the user with a virtual design center (2008) where the user has the option to edit or modify the picture. The user may add borders to the picture, enhance color, brightness, crop the picture, etc. After the user is satisfied with any editing or modification of the picture, the user may confirm the ordering of the product (2010). Ordering the product may include making payment arrangements as well as, identifyin the destination where the product is to be delivered. Obviously, multiple products may be ordered and shipped to the same or multiple addresses. A gift card may also be created as part of the ordering step. In addition payment arrangements are to be made as part of the ordering of the product. Payment may be made through customary credit card channels, customary alternate billing arrangements and/or by charging to the mobile phone account. The user may also choose to share the selected picture and/or created product on the Internet via the social network account associated with the user (2012) and people connected via the social network to the user's account may be notified that the picture is available for viewing. The user may also choose to upload the created product to an online marketplace or a mobile marketplace to sell (2014). The foregoing generally completes the “ordering” process and the sale or transaction is considered by the consumer to be completed (2016).

When the user finishes creating a new product on the hand-held device, the software is configured to send two images to either the server or fulfillment application.

The first is the image that the user created and the second is the combination of the user-created image and product image illustrating how one is superimposed over the other. Other data files that represent and communicate this information may also be used. These images are saved and stored by the server or fulfillment application. The user may be able to access the server or fulfillment application to check the status of their creations, or for other purposes. One or both images may be sent to the user (e.g., the created of the product) to the resident application, so that is displayed for the user on the application. The transmitted image(s) can be part of the interface that allows the user to check how well his or her creation is selling,

The present system, method, and computer-readable storage medium includes a fulfillment system which receives the information via the mobile application (2018) and thereafter, coordinates the incorporation of the photograph onto the selected product and shipping the finished product according to the shipping instructions from the user. The online marketplace application programming interface (API) communicates the created product information to the fulfillment system (2020). A mobile marketplace may also include an API that communicates the created product information to the fulfillment system.

In some respects, a service is contemplated that implements an arrangement of a remote services and fulfillment application with mobile applications to allow individuals to quickly create and order products for themselves or others. The resident application has a preconfigured network, software, and communications relationship with a fulfillment application over a network. The relationship can be provided by implementing a communication exchange or protocol and/or address that he devices can use to automatically engage each other.

In some embodiments, more than one resident application on a mobile device can be implemented as opposed to a single resident application. For example, one resident application can create an image on the hand-held devices, a second resident application can provide a design center, and a third can handle the order and commercial aspects of the operation. APIs or other integration tools can be implemented if desired to connect different resident applications.

The fulfillment system receives the incoming order (2018) (which corresponds to the completed order (2016)) and then confirms that satisfactory financial arrangements have been made, the online marketplace or the mobile marketplace approval and denying process (2022). Notification is sent to the user via the mobile application when the transaction is approved (2024). The system also communicates information received from monitoring or tracking the fulfillment of the order to confirm shipment of the customized merchandise to the user.

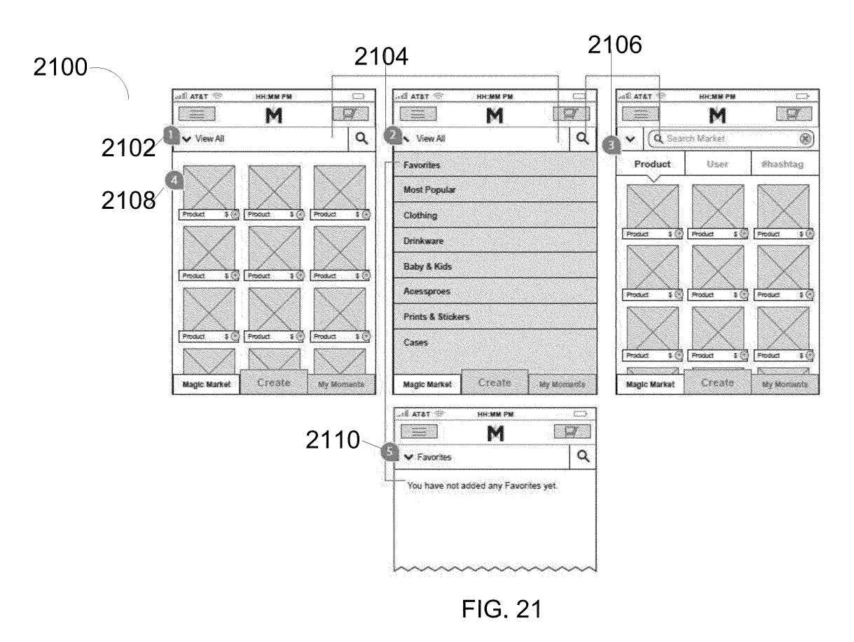

Now referring to FIG. 21, which is another exemplary interface of the mobile application 2100. The user might see interface 2100 after selecting a button that says mobile marketplace or something of the like in a main interface screen, after the user places an order, or other interface screen. The mobile marketplace may be a place that a user can view other products made by other users or view their own products. The mobile marketplace interface 2100 provides multiple different search or find options to the user to find specific products or specific types of products. The user might want to view all products that are available in the online or mobile marketplace 2102, A default setting for the view all view 21.02 might be sorted by most recently made to less recently made products but it should be appreciated that the view all view 2102 may be sorted or viewable in many different formats and options.

For example the user might want to browse by product category 2104. Browse by market product category 2104 may provide the user with multiple different categories. For example, if the user is searching for a T-shirt, the user would select T-shirt and might be able to view all the recently other user made T-shirts. The browse-by-market product category may present the categories in multiple different ways including, but not limited to, drop down selectable menus.

Option 2106 might be to provide a search text field within the online or mobile marketplace so that the user might be able to type in a search query. The search query could consist of many different possibilities, such as product type, tags, title, username, etc. The search query would return products that closely fit to the search query provided by the user. The results of the search query may be displayed as thumbnail versions of the product 2108 within the interface 2100.

Another option for viewing or navigating the online or mobile marketplace may be viewing user defined favorites 2110. The user might be able to select favorite categories, products, usernames, etc. A favorite option might be available in any and all of the interfaces discussed herein. Once the user selects an object or item as a favorite, the product or item will appear in this list for easy retrieval at a later time.

The mobile resident application, hand-held or mobile devices, fulfillment application, server, or other discrete software or hardware components can communicate and are arranged to carry out the illustrative processes and applications described herein by way of sending a signal such as a packet digital message, or a command within a communication to or between components (and act in response to the receipt of a signal to carry our processes) and between or through supporting software or hardware such as communicating with an operating system, communicating with another resident application through an API or the like, communicating between network elements using an Internet protocol or one or more layers of the OSI model, or communicating through an intermediate component.

The resident mobile application may operate in coordination with application software running external to the hand-held or mobile device to carry out or provide the intended customization and application. For example, the resident application may interact with another software to authenticate a user, check the status of a user's account, or carry out financial transactions. Providing software features that are subsidiary or are tangential to create and buy or sell functionality or the linked marketplace application can be incorporated into the mobile resident application or can be provided in conjunction or coordination with other software if desired.

A computing device can include a computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment discussed and illustrated is not intended to limit the present disclosure, and that other alternative hardware and/or software environments may be used without departing from the scope of this disclosure. The present techniques can be applied to devices other than hand-held devices, such as laptops or desktop computers.

For clarity, as used herein, the term “server” includes one or more servers. A server can include one or more computers that manage access to a centralized resource or service in a network. A server can also include at least one program that manages resources (for example, on a multiprocessing operating system where a single computer can execute several programs at once). Further, the terms “computing device”, “computer device” “computer” and “machine” are understood. to be interchangeable terms and shall be taken to include any collection of computing devices that individually or jointly execute a set or multiple sets) of instructions to perform any one or more of the methods discussed herein.

The local storage can include volatile memory (such as RAM) and/or non-volatile memory (such as ROM as well as any supplemental levels of memory, including but not limited to cache memories, programmable or flash memories and read-only memories). The portable computing device or hand-held device can include one or more processing devices (e.,g, one or more central processing units (CPUs), one or more graphics processing units (GPUs), one or more microprocessors (μP) and similar and complementary devices) and optional media devices (e.g,, a hard disk module, an optical disk module, etc.)Additionally, any storage techniques used in connection with the presently disclosed method and/or system may invariably be a combination of hardware and software.

In some instances, the term resident application is used to refer to an installed mobile application. However. as a matter of convenience mobile application and resident application are used interchangeably.

One or more features illustratively described herein can be implemented individually or in various combinations. The present system, method, or related inventions also relate to a non-transient computer readable medium configured to carry out any one of the methods disclosed herein. The application can be set of instructions readable by a processor and stored on the non-transient computer readab e medium. Such medium may be permanent or semi-permanent memory, such as hard drive, floppy drive, optical disk, flash memory, ROM, EPROM, EEPROM, etc., as would be known to those of ordinary skill in the art.

Features or characteristics described in one context, process, or device are applicable to other context, process or devices described herein. The steps of the processes illustratively described herein can be performed in a different order, if desired. Also, steps could be added or removed from the processes illustratively described herein. The processes illustratively described herein can be implemented using the described examples of hardware and ‘network configurations.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the claims to the invention.

What is claimed is:

1. A method for creating and selling user-customized products, comprising:
providing a create-and-sell mobile application configured to be installed on a hand-held device to add a new resident application on the hand-held device and when installed associates a user of the resident application with an online marketplace for selling products created by the user in the resident application;
receiving within the resident application an image from an mboard source of locally-generated content on the hand-held device;
receiving, within the resident application, product images for physical products that can be sold by the user on the online marketplace through local user-interaction with the resident application;
providing an interface within the resident application that is configured to permit the user of the hand-held device to use a display of the hand-held device to superimpose the received image on at least one of the product images, whereby the user creates a new product;
receiving gestures from the user to manipulate the interface; and
providing a selectable option within the resident application that when selected instructs the online marketplace to automatically contain a point of sale that merchandises the created product over the Internet and establishes a financial relationship between the user and the online marketplace.

2. The method. of claim 1, further comprising providing a second selectable option within the mobile application that when selected instructs a social network to automatically publish the image or created product to an account of the social network associated with the user.

3. The method of claim 2, wherein the interface further comprises displaying status and information about other users associated with the social network account associated with the user.

4. The method of claim 1, the resident application further comprising providing a design center for editing the selected image.

5. The method of claim 1, wherein the financial relationship between the user and the online marketplace includes the user receiving a percentage of the sales of the user's created product.

6. The method of claim 1 further comprising:
receiving an incoming order of the created product from the online marketplace;
receiving financial relationship information about a customer from the online marketplace;
processing the order; and
providing the customer with progress of the order.

7. A system for creating and selling user-customized products, comprising:
an online marketplace for selling products created by a user;
a create-and-sell mobile application that is configured to:
be installed on a hand-held device to add a new resident application on the hand-held device and when installed associates the user of the resident application with the online marketplace for selling products created by the user in the resident application;
receive within the resident application an image from an onboard. source of locally-generated content on the hand-held device;
receive, within the resident application, product images for physical products that can be sold by the user on the online marketplace through local user-interaction with the resident application;
provide an interface within the resident application that is configured to permit the user of the hand-held device to use a display of the hand-held device to superimpose the received image on at least one of the product images, whereby the user creates a new product;
receive gestures from the user to manipulate the interface; and
provide a selectable option within the resident application that when selected instructs the online marketplace to automatically contain a point of sale that merchandises the created product over the Internet and establishes a financial relationship between the user and the online marketplace.

8. The system of claim 6, the create-and-sell mobile application further configured to provide a second selectable option within the mobile application that when selected instructs a social network to automatically publish the image or created product to an account of the social network associated with the user.

9. The system of claim 7, the interface further configured to display status and information about other users associated. with the social network account associated with the user.

10. The system of claim 6, the create-and-sell mobile application further configured to provide a design center for editing the selected image.

11. The system of claim 6, wherein the financial relationship between the user and the marketplace includes the user receiving a percentage of the sales of the user's created product.

12. The system of claim 6, further comprising a application server that facilitates communication between the online marketplace and a create-and-sell mobile application.

13. The system of claim 6 further comprising:
a fulfillment system that is configured to;
receive an incoming order of the created product from the online marketplace;
receive financial relationship information about a customer from the online marketplace;
process the order; and
provide the customer with progress of the order.

14. A computer-readable storage medium comprising instructions executable by a processor to perform a method for creating and selling user-customized products, comprising:
providing a create-and-sell mobile application configured to be installed on a hand-held device to add a new resident application on the hand-held device and when installed associates a ⁻user of the resident application with an online marketplace for selling products created by the user in the resident application;
receiving within the resident application an image from an onboard source of locally-generated content on the hand-held device;
receiving, within the resident application, product images for physical products that can be sold by the user on the online marketplace through local user-interaction with the resident application;
providing an interface within the ‘resident application that is configured to permit the user of the hand-held device to use a display of the hand-held device to superimpose the received image on at least one of the product images, whereby the user creates anew product;
receiving gestures from the user to manipulate the interface; and
providing a selectable option within the resident application that when selected instructs the online marketplace to automatically contain a point of sale that merchandises the created product over the Internet and establishes a financial relationship between the user and the online marketplace.

15. The computer-readable medium of claim 11, the create-and-sell mobile application further comprising providing a second selectable option within the mobile application that when selected instructs a social network to automaticallyr publish the image or created product to an account of the social network associated with the user.

16. The computer-readable medium of claim 12, wherein the interface farther comprising displaying status and information about other users associated with the social network account associated with the user.

17. The computer-readable medium of claim 11, the create-and-sell mobile application further comprising providing a design center for editing the selected image.

18. The computer-readable medium of claim 11, wherein the financial relationship between the user and the online marketplace includes the user receiving a percentage of the sales of the user's created product.

19. The computer-readable medium of claim 11 further comprising:
receiving an incoming order of the created product from the online marketplace;
receiving financial relationship information about a customer from the online marketplace;
processing the order; and.
providing the customer with proffessing of the order.

20. A method for creating and buying user-customized products, comprising:
providing a create a product mobile application configured to be installed on a hand-held device so that when installed a new resident application is added to the hand-held device;
receiving within the resident application a user-created image from an onboard source of locally-generated content on the hand-held device;
receiving, within the resident application, product images for physical products that can be used by the user to create customized new products;
establishing a fulfillment relationship for fulfilling orders of customized products created in the resident application between the resident application and a fulfillment application, wherein the fulfillment application is configured to receive information from the resident application and coordinate incorporation of images into products and shipping of finished products to one or more destinations for individual finished products;
providing an interface within the resident application that is configured to permit the user of the hand-held device to use a display of the hand-held device to superimpose the received image on at least one of the product images, whereby the user creates a new product; and
providing a selectable option within the resident application that when selected instructs the resident application to transmit data represeutative of the created product to the fulfillment application over the Internet and establishes a financial relationship between the user and the fulfillment application in connection with the created product.

21. The method of claim 16, the create-and-buy mobile application further comprising providing a second selectable option within the mobile application that when selected instructs asocial network to automatically publish the image or created product to an account of the social network associated with the user.

22. The method of claim 17, wherein the interface further comprising displaying status and information about other users associated with the social network account associated with the user.

23. The method of claim 16, the create-and-buy mobile application further comprising providing a design center for editing the selected image.

24. The method of claim 16, wherein the financial relationship between the user and the server includes the user receiving a percentage of the sales of the user's created product,

25. The method of claim 16 further comprising:
receiving an incoming order of the created product from the online marketplace;
receiving the financial relationship information from the online marketplace;
processing the order; and
providing the user with progress of the order.
